(19) United States
(12) Patent Application Publication
(10) Pub. No.: US 2004/0167664 A1
(43) Pub. Date: Aug. 26, 2004

(54) Dispenser Activation Control System

(76) Inventor: Dowell Williams Griffin, Fort Worth, TX (US)

Correspondence Address: DOWELL GRIFFIN, 8421 CROSSWIND DR., FORT WORTH, TX, 76179, US

(21) Appl. No.: 10/248,850

(22) Filed: Feb. 24, 2003

(51) Int. Cl. G06F 17/00

(52) U.S. Cl. 700/237

(57) ABSTRACT

The Dispenser Activation Control System (DACS) provides an automated mechanism to control how many times a dispenser will dispense product in the presence of the same activator. Encoded activators are used to enable the dispenser so it can be operated. The main components are: A sensor, a processing unit, a memory device and encoded activators.

### BACKGROUND OF INVENTION

Definitions Used in this Document:

Dispenser—any device used to dispense product from a holding container. A dispenser normally has a mechanical or electronic switch (primary switch) used to start and stop dispensing.

Dispenser Activation Control System (DACS)—a system to control how many times a dispenser can be activated by the same activator to allow dispensing of product. The words “same activator” and “how many times” are important to the concept being presented in this document. “Same” is meant to construe the identical activator and not another similar item. “How many times” is meant indicate an integer number from zero through infinity.

Activator—the device that the DACS sensor reads or detects to determine if dispensing is permitted. An activator might be integrated into a cup, a handheld card, or other “readable” items including but not limited to: barcode, fingerprint, retinal scan, voice pattern recognition, an encoded value received via radio frequency or light pulses, or handwriting recognition.

Example application for the DACS: It provides the ability for establishments serving beverages via a fountain or similar device to control the number of refills a customer can have. This is not the only application for the DACS.

Examples of commonly used retail dispensing approaches are: 1) The in-store workers fill beverage cups for the customer thereby avoiding re-fill abuse and unlimited refills (the dispenser is not accessible to customers) 2) A dispenser is placed in a location such that customers can fill and re-fill their beverage cups on their own.

Problems resulting from the above mentioned approaches reduce profits from beverage sales: In approach (1) above, the owner has control over customer refills thereby avoiding abuse and waste. This requires that workers spend valuable time filling drink cups. This approach may also be annoying to customers since they must to wait in a queue to get a refill.

In approach (2) above, the owner has no control over customer refills. A customer can purchase a small beverage, when they really wanted a large, and refill their cup as many times as they want. The owner has missed a sale opportunity.

### SUMMARY OF INVENTION

The Dispenser Activation Control System provides an automated mechanism to control whether a dispenser will dispense product. An encoded activator is used to enable the dispenser.

### DETAILED DESCRIPTION

Explanation of how the Dispenser Activation Control System (DACS) works:

Part of the DACS is normally integrated into a dispenser to activate or deactivate the dispenser. The dispenser's primary switch will be used to start and stop actual dispensing when the DACS has activated the dispenser.

A sensor detects (reads, hears, or sees) an identifier (code or pattern) from the activator, which is external to the dispenser yet part of “the system”, and conditionally activates the dispenser. If the activator has reached the number of refills allowed, which is determined by the processing unit of the DACS, the dispenser will not operate. Optionally, an indicator will let a user know their “refill limit” has been met. The DACS remembers how many times an activator has been used to dispense a product. A processing unit manages the information, memory, algorithms, and interfaces of the DACS.

An optional configuration of this system would be to record how many times an activator is used. This count would be displayed to a worker when the customer “checks out” or pays their bill.

There are several technologies that will be used to implement the DACS. These include, but are not limited to blue-tooth short-range radio frequency, bar codes, fingerprints and voice recognition. A microprocessor could be used as the processing unit and an accompanying memory device would be used to keep track of the number of times an activator was used.

The DACS is flexible to meet the users or owner's requirements for a dispenser. A restaurant owner could sell an unlimited refill option for beverages and the workers would give the customer a cup (activator) that is recognized as such by the DACS. The owner could select a one-refill option and a no-refill option as well. Workers give the customer the appropriate cup or other activator at the time of sale based on the refill option purchased.

1) I have invented a system that controls how many times a dispenser will dispense product in the presence of the same activator. It is comprised of a switch, a sensor, encoded activators, a memory device, and a processing unit. When the activator is within certain proximity of the sensor the sensor reads, hears, sees or otherwise detects the activator and the coded value from the activator is sent to the processing unit. The processing unit determines whether the dispenser should be activated. When this system activates the dispenser normal operation of the dispenser can occur thereby allowing product to be dispensed. The system will deactivate the dispenser after a programmable timeout period, or when the dispenser's primary switch is turned off, or by a combination of both of these based on a selectable algorithm.

2) A system as described in (1) above with components being near or on a dispenser of food or beverages so as to control whether a food or beverage is dispensed.

3) A system as described in (1) above with a barcode residing on the surface of a container and other components being near or on a dispenser of food or beverages so as to control whether a food or beverage is dispensed.
